(19) United States
(12) Patent Application Publication
(10) Pub. No.: US 2026/0278077 A1
(43) Pub. Date: Sep. 17, 2026

(54) Enabling Efficient Usage-Based-Disturbance Mitigation

(71) Applicant: Micron Technology, Inc., Boise, ID (US)

(72) Inventor: Yang Lu, Boise, ID (US)

(73) Assignee: Micron Technology, Inc., Boise, ID (US)

(21) Appl. No.: 19/079,285

(22) Filed: Mar. 13, 2025

(51) Int. Cl. G06F 21/55; G06F 21/62

(52) U.S. Cl. CPC G06F 21/554; G06F 21/6227; G06F 2221/034

(57) ABSTRACT

Apparatuses and techniques for enabling efficient usage-based-disturbance (UBD) mitigation are described. Mitigating the adverse effects of UBD can entail tracking a quantity of accesses to memory rows using activation counts. Generally, the activation count of a particular row can be reset to zero based on memory refresh operations applied to the particular row and proximate rows thereof. The multiple storage bits for the UBD data consume chip area, and manipulating the storage bits consumes power. Described implementations increase the effective quantity of UBD data bits without increasing chip area. By the strategic placement of a refresh flag in proximity to certain bits of the activation count, power can be saved when manipulating the UBD data in response to a refresh operation by asserting the relevant column select circuitry. Further, enhancing the evaluation of a refresh boundary can facilitate updating the activation count during memory access read and write operations.

### BACKGROUND

Computers, smartphones, and other electronic devices rely on processors and memories. A processor executes code based on data to run applications and provide features to a user. The processor obtains the code and the data from a memory. The memory in an electronic device can include volatile memory (e.g., random-access memory (RAM)) and non-volatile memory (e.g., flash memory). Like the capabilities of a processor, the capabilities of a memory can impact the performance of an electronic device. This performance impact can increase as processors are developed that execute code faster and as applications operate on increasingly larger data sets that require ever-larger memories.

### BRIEF DESCRIPTION OF THE DRAWINGS

Apparatuses of and techniques for enabling efficient usage-based-disturbance mitigation are described with reference to the following drawings. The same numbers are used throughout the drawings to reference like features and components:

FIG. 1 illustrates example apparatuses that can implement aspects of enabling efficient usage-based-disturbance mitigation;

FIG. 2 illustrates example computing systems that can implement aspects of enabling efficient usage-based-disturbance mitigation;

FIG. 3 is a schematic diagram illustrating example approaches to storing data within rows of a memory array to support usage-based-disturbance mitigation, including to support efficient implementations of usage-based-disturbance data as described herein;

FIG. 4 is a schematic diagram illustrating multiple storage bits that can hold example implementations of usage-based-disturbance data for enabling efficient usage-based-disturbance mitigation;

FIGS. 5-1, 5-2, and 5-3 are block diagrams illustrating example implementations for different bit assignments for the multiple storage bits of the usage-based-disturbance data of FIG. 4;

FIG. 6 is a schematic diagram illustrating example techniques for refresh logic to operate column select circuitry as part of a refresh operation in relation to usage-based-disturbance data;

FIG. 7 is a schematic diagram illustrating example techniques for performing a refresh operation and an update operation on normal data and usage-based-disturbance data that are stored in a row of a memory array;

FIG. 8 is a schematic diagram illustrating example techniques for a usage-based-disturbance mitigation circuit to determine a refresh boundary, which can be used with updating usage-based-disturbance data in conjunction with a memory access operation;

FIG. 9 illustrates an example method for efficiently updating usage-based-disturbance data in conjunction with a memory access operation;

FIG. 10 illustrates an example method for efficiently updating usage-based-disturbance data in conjunction with a refresh operation; and

FIG. 11 illustrates an example method for enabling efficient usage-based-disturbance mitigation.

### DETAILED DESCRIPTION

### Overview

Processors and memory work in tandem to provide features to users of computers and other electronic devices. As processors and memory operate more quickly together in a complementary manner, an electronic device can provide enhanced features, such as high-resolution graphics and artificial intelligence (AI) analysis. Some applications, such as those for financial services, medical devices, and advanced driver assistance systems (ADAS), can also demand more-reliable memories. These applications rely on increasingly reliable memories to limit errors in financial transactions, medical decisions, and object identification, respectively. In some implementations, however, more-reliable memories can sacrifice bit density, power efficiency, and simplicity.

Generally, a memory device is expected to service memory requests from a host device within predetermined time periods and/or with predictable delay durations. These constraints mean that the memory device prioritizes memory requests from an external entity, such as a memory controller of a host device. A modern memory device, however, has additional expectations or obligations beyond servicing memory requests. For example, to create a more-reliable memory, a memory device is expected to combat attacks from bad actors, such as usage-based-disturbance (UBD) attacks, which are described below. Thus, a memory device may perform usage-based-disturbance mitigation operations in conjunction with servicing memory requests.

It can be challenging, however, to perform “secondary” functionalities without unduly impacting the performance of a memory device's core duty of servicing memory requests. Accordingly, this document describes apparatuses and techniques for combating usage-based disturbances in manners that are efficient in terms of area, cost, speed, and power to reduce their impact on the servicing of memory requests. The UBD phenomenon is described next, and that description is followed by schemes for counteracting the potential harms that can arise from usage-based disturbance.

To meet the demands for physically smaller memories with greater capacities, memory devices can be designed with higher chip densities by reducing the size of the memory cells. Increasing chip density, however, can increase the electromagnetic coupling between proximate rows of memory cells due, at least in part, to a shrinking distance between these rows. With this undesired electromagnetic coupling (e.g., capacitive coupling), activation (or charging) of a first row of memory cells can sometimes negatively impact the integrity of the digital values stored in a second nearby row of memory cells. This phenomenon is referred to herein as usage-based disturbance. Activation of the first row can generate interference, or crosstalk, that causes the second row to experience a voltage fluctuation. In some instances, this voltage fluctuation can cause a state, or value, of a memory cell in the second row to be incorrectly determined by a sense amplifier. Consider an example in which a state of a memory cell in the second row is a logical “1” (e.g., a high voltage). In this example, the voltage fluctuation can cause a sense amplifier to incorrectly determine the state of the memory cell to be a logical “0” (e.g., a low voltage) instead of a logical “1.” Left unchecked, this interference can lead to memory errors or data loss within the memory device.

In some circumstances, a particular row of memory cells is activated repeatedly in an unintentional manner or in an intentional manner, which can be part of a malicious act. Such a row that is repeatedly activated is referred to herein as an aggressor row. Consider, for instance, that memory cells in an R^{th} row are subjected to repeated activation, which causes one or more memory cells in a proximate row (e.g., an adjacent row) to change states. Here, a proximate row can include: a row within an R+1 row, which is an adjacent row; an R+2 row; an R−1 row, which is another adjacent row; and/or an R−2 row. These proximate rows are referred to herein as victim rows. The effect of changed memory states in a victim row due to repeated activations of an aggressor row is referred to as a usage-based disturbance. The occurrence of usage-based disturbance can lead to the corruption or changing of contents within the affected row(s) of memory.

To combat the negative effects of usage-based disturbance, a memory device can perform UBD mitigation operations. For example, a memory device can perform a mitigation procedure that includes a refresh pump to recharge one or more rows that are near an activated row to mitigate the usage-based disturbance. The refresh pump “fully” restores the correct charge in the memory cells of a victim row by reading out the current voltage levels and writing the digital values back to the memory cells using the full correct voltage levels. To determine if a victim row is in danger of being adversely affected by usage-based disturbance, a quantity of accesses of aggressor rows is tracked using an activation counter. When the activation count meets or exceeds a threshold, the memory device can perform the refresh pump on one or more victim rows.

In addition to UBD mitigation operations, a memory device may be designed to perform other types of operations to improve performance, even if such operations do not directly support responding to a regular memory input/output request. For instance, a memory device may perform an error check and scrub (ECS) operation. ECS can be used to provide error correction code (ECC) transparency and error remediation. The ECC transparency and remediation can entail error monitoring, such as error counting and categorizing. An issue with performing these operations is that such operations use some of the same array-accessing circuitry that is used to respond to external memory input/output requests. This circuitry can include sense amplifiers, write drivers, word lines, or bit lines. Consequently, fulfilling memory read and write requests for a host device can be slowed or even blocked while performing these other operations. This document describes schemes to efficiently enable performance of UBD mitigation operations while reducing their impacts on fulfilling read and write requests.

Generally, a memory device is designed to attempt to perform these “non-core” functionalities in manners to limit their interference with responding to “core” memory requests. One approach involves leveraging time intervals that are already assigned to perform functionality that does not entail reading or writing data for an external host. These time intervals relate, for instance, to refreshing memory to preserve a stored charge. The refresh-related time intervals can be “confiscated” (e.g., “appropriated,” “commandeered,” or “stolen”) for other purposes, such as UBD mitigation. Refreshing memory and the time intervals that are used for memory refreshing are described next.

Memory devices store data using memory cells. With some volatile memory devices, such as those using dynamic random-access memory (DRAM), each memory cell can store one bit of data with a capacitor using a voltage level (e.g., a high or low voltage level) of the capacitor. Unfortunately, each memory cell of a volatile memory array can leak charge from the capacitor over time. The charge leakage can cause the memory device to eventually lose the data stored by the capacitor. To remediate this charge leakage, the memory device periodically refreshes the charge on the memory cells using a refresh pump to restore the intended voltage level.

Especially as memory devices are designed with larger storage capacities, timing resources can become constrained due to the refreshing of larger quantities of memory cells within a given integrated circuit die or memory module. The limited timing resources available for performing refreshes, in conjunction with the increased quantities of memory cells, can add further challenges to mitigating usage-based disturbance. In other words, it can be difficult to confiscate enough refresh pump opportunities to safely keep the memory refreshed while also performing other internal operations without unduly impacting actual read/write memory operations. As memory devices increase the quantity of stored bits per integrated circuit chip (IC chip), there is a need to ensure that the timing resources available for performing UBD mitigation are efficiently utilized.

As described herein, to maintain the integrity of data stored in DRAM cells, refresh pumps are provided to rows of the memory during refresh-pump time intervals. A percentage of these refresh-pump time intervals can be confiscated for other purposes. The quantity of refresh-pump time intervals that can be confiscated is limited, however, to avoid losing data in the DRAM cells or to meet a targeted specification parameter of the memory device, such as maximum latency or minimum bandwidth. Accordingly, the confiscated refresh-pump time intervals should be used efficiently. In some approaches, a confiscated refresh-pump time interval is assigned to at least one UBD mitigation operation.

As described herein for UBD mitigation, a memory device tracks how often each row has been activated. An activation count for each row can be incremented by some value (e.g., by one) responsive to each row access. In example ongoing operations, control circuitry compares an activation count of each row to at least one threshold (e.g., a mitigation threshold or an alert threshold). This comparison may be performed, for instance, in response to each row activation or row precharge. Generally, if a victim row is at risk due to the activation count of an aggressor row, the control circuitry permits (e.g., commands, queues up, or otherwise causes) a UBD mitigation operation to be performed on the victim row. In some cases, usage-based-disturbance data including activation counters that store activation counts are positioned near (e.g., proximate to or at) each memory bank. The UBD data for an aggressor row may, for instance, be included as part of a corresponding row that includes the normal data of the aggressor row.

Usage-based-disturbance data mitigation functionality can be time-sensitive. For example, if a UBD mitigation operation is not performed in a timely manner, an alert condition may be created if a row activation count meets a given threshold (e.g., an alert threshold). To resolve the alert condition, the memory device stops servicing commands from a host device (e.g., a memory controller) and dedicates resources to performing UBD mitigation operation(s). Thus, the user experience is adversely impacted due to the memory system stalling even if data is not compromised. Further, a failure to timely perform UBD mitigation operations can result in data errors or appreciable service latencies after just seconds, or even after just part of a second if the memory device is under attack.

In approaches that are described herein, however, a memory device can perform UBD operations in a more efficient manner in terms of cost, energy usage, and time. For example, the multiple bits that store usage-based-disturbance data can be used more efficiently. In some cases, the quantity of parity bits is halved (e.g., from two parity bits to one parity bit) by scheduling and performing the resetting of the activation count as described herein. The total quantity of usage-based-disturbance bits may therefore be reduced. Alternatively, the “extra” bit can be used to increase the maximum activation count value.

In another example, the UBD data includes a refresh flag. The refresh flag enables an activation count of an aggressor row to continue to increase after the aggressor row has been refreshed while potential victim rows remain unrefreshed. This enables the refresh gap between proximate rows to be handled more efficiently. Further, in response to the refresh operation on the aggressor row, fewer than all bits of the activation count can be initialized or reset. For instance, the activation count bits of the activation counter that are coupled to the same column select as the refresh flag can be adjusted (e.g., reset) while other activation count bits are unchanged to save power.

In yet another example, a refresh boundary evaluation can provide additional information to facilitate the updating of an activation count in response to an activation or precharge operation. Instead of only providing an indication of whether a previous refresh operation was directed to the currently activated row, the refresh boundary evaluation can indicate if the previous refresh operation was directed to the currently activated row or if the next refresh operation will be directed to the currently activated row. This expands the ability of the UBD logic to account for potential victim rows that have not yet been mitigated or refreshed. In these manners, implementing the techniques described herein for enabling efficient usage-based-disturbance mitigation can reduce costs, increase mitigation options, lower energy usage, or decrease delays caused by UBD mitigation, including providing two or more of these advantages.

### Example Operating Environments

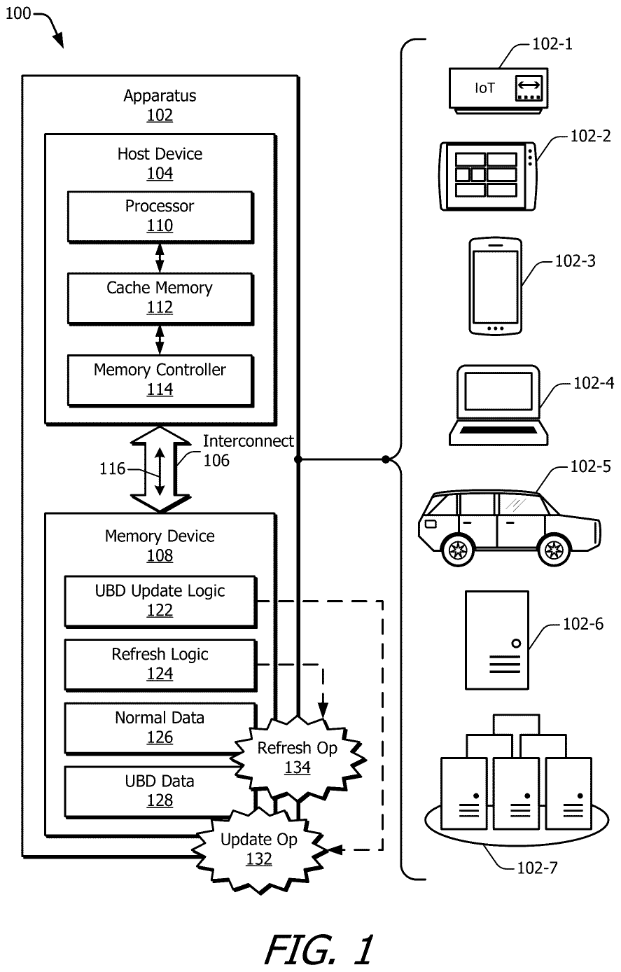

FIG. 1 illustrates, at 100 generally, an example operating environment including an apparatus 102 that can implement aspects of enabling efficient usage-based-disturbance mitigation. The apparatus 102 can include various types of electronic devices, including an internet-of-things (IoT) device 102-1, a tablet device 102-2, a smartphone 102-3, a notebook computer 102-4, a passenger vehicle 102-5, a server computer 102-6, and a server cluster 102-7. The server computer 102-6 or the server cluster 102-7 may be part of cloud computing infrastructure, a data center, a portion thereof (e.g., a printed circuit board (PCB) or data center rack), and so forth. Other examples of the apparatus 102 include a wearable device (e.g., a smartwatch or intelligent glasses), an entertainment device (e.g., a set-top box, video dongle, smart television, a gaming device), a desktop computer, a motherboard, a server blade, a consumer appliance, a vehicle, a drone, industrial equipment, a security device, a medical device, a sensor, or the electronic components thereof. Each type of apparatus can include one or more components to provide computing functionalities or features.

In example implementations, the apparatus 102 can include at least one host device 104, at least one interconnect 106, and at least one memory device 108. The host device 104 can include at least one processor 110, at least one cache memory 112, and at least one memory controller 114. The memory device 108, which can also be realized with a memory module, can include, for example, a dynamic random-access memory (DRAM) die or module (e.g., Low-Power Double Data Rate synchronous DRAM (LPDDR SDRAM)). The DRAM die or module can include a three-dimensional (3D) stacked DRAM device, which may be a high-bandwidth memory (HBM) device or a hybrid memory cube (HMC) device. The memory device 108 can operate as a main memory for the apparatus 102. Although not illustrated, the apparatus 102 can also include storage memory. The storage memory can include, for example, a storage-class memory device (e.g., flash memory, hard disk drive, solid-state drive, phase-change memory (PCM), or memory employing 3D XPoint™).

The processor 110 is operatively coupled to the cache memory 112, which is operatively coupled to the memory controller 114. The processor 110 is also coupled, directly or indirectly, to the memory controller 114. The host device 104 may include other components to form, for instance, a system-on-a-chip (SoC). The processor 110 may include a general-purpose processor, a central processing unit (CPU), a graphics processing unit (GPU), a neural network engine or accelerator, an application-specific integrated circuit (ASIC), a field-programmable gate array (FPGA) integrated circuit (IC), a communications processor (e.g., a modem or baseband processor), and so forth.

In operation, the memory controller 114 can provide a high-level or logical interface between the processor 110 and at least one memory (e.g., an external memory). The memory controller 114 may be realized with any of a variety of suitable memory controllers (e.g., a double-data-rate (DDR) or synchronous memory controller that can process requests for data stored on the memory device 108). Although not shown, the host device 104 may include a physical interface (PHY) that transfers data between the memory controller 114 and the memory device 108 through the interconnect 106. For example, the physical interface may be an interface that is compatible with a DDR PHY Interface (DFI) Group interface protocol. The memory controller 114 can, for example, receive memory requests from the processor 110 and provide the memory requests to external memory with appropriate formatting, timing, and reordering. The memory controller 114 can also forward to the processor 110 responses to the memory requests (e.g., read data or write confirmation) that are received from external memory.

The host device 104 is operatively coupled, via the interconnect 106, to the memory device 108. In some examples, the memory device 108 is connected to the host device 104 via the interconnect 106 with an intervening buffer or cache. The memory device 108 may operatively couple to storage memory (not shown). The host device 104 can also be coupled, directly or indirectly via the interconnect 106, to the memory device 108 and the storage memory. The interconnect 106 and other interconnects (not illustrated in FIG. 1) can transfer data between two or more components of the apparatus 102. Examples of the interconnect 106 include a bus (e.g., unidirectional bus, bidirectional bus, or memory bus), a switching fabric, or one or more wires that carry voltage or current signals. The interconnect 106 can propagate one or more communications 116 between the host device 104 and the memory device 108. For example, the host device 104 may transmit a memory request to the memory device 108 over the interconnect 106. Also, the memory device 108 may transmit a corresponding memory response to the host device 104 over the interconnect 106.

The illustrated components of the apparatus 102 represent an example architecture with a hierarchical memory system. A hierarchical memory system may include memories at different levels, with each level having memory with a different speed or capacity. As illustrated, the cache memory 112 logically couples the processor 110 to the memory device 108. In the illustrated implementation, the cache memory 112 is at a higher level than the memory device 108. A storage memory, in turn, can be at a lower level than the main memory (e.g., the memory device 108). Memory at lower hierarchical levels may have decreased speed but increased capacity or lower cost relative to memory at higher hierarchical levels. Accordingly, the memory device 108 can form at least part of the main memory of the apparatus 102. Additionally or alternatively, the memory device 108 may form at least part of a cache memory, a storage memory, or a system-on-chip of the apparatus 102.

The apparatus 102 can be implemented in various manners with more, fewer, or different components. For example, the host device 104 may include multiple cache memories (e.g., including multiple levels of cache memory) or no cache memory. In other implementations, the host device 104 may omit the processor 110 or the memory controller 114. A memory (e.g., the memory device 108) may have an “internal” or “local” cache memory. As another example, the apparatus 102 may include cache memory between the interconnect 106 and the memory device 108. Computer engineers can also include any of the illustrated components in distributed or shared memory systems.

Computer engineers may implement the host device 104 and the various memories in multiple manners. In some cases, the host device 104 and the memory device 108 can be disposed on, or physically supported by, the same printed circuit board (e.g., a rigid or flexible motherboard) or different printed circuit boards (PCBs). The host device 104 and the memory device 108 may additionally be integrated together on an integrated circuit or fabricated on separate integrated circuits and packaged together. The memory device 108 may also be coupled to multiple host devices 104 via one or more interconnects 106 and may respond to memory requests from two or more host devices 104. Each host device 104 may include a respective memory controller 114, or the multiple host devices 104 may share a memory controller 114.

Thus, this document describes with reference to FIG. 1 an example computing system architecture having at least one host device 104 coupled to a memory device 108. Two or more memory components (e.g., modules, dies, bank groups, or memory banks) may share the electrical paths or couplings of the interconnect 106 that can extend between the host device 104 and the memory device 108. The interconnect 106 can include at least one command-and-address bus (CA bus) and at least one data bus (DQ bus), which are not separately depicted. The command-and-address bus can transmit addresses and commands from the memory controller 114 of the host device 104 to the memory device 108. In some cases, the command-and-address bus may exclude the propagation of data. The data bus can propagate data between the memory controller 114 and the memory device 108. The memory device 108 may also be implemented as any suitable memory including, but not limited to, DRAM, SDRAM, three-dimensional (3D) stacked DRAM, DDR memory, or LPDDR memory (e.g., LPDDR DRAM or LPDDR SDRAM).

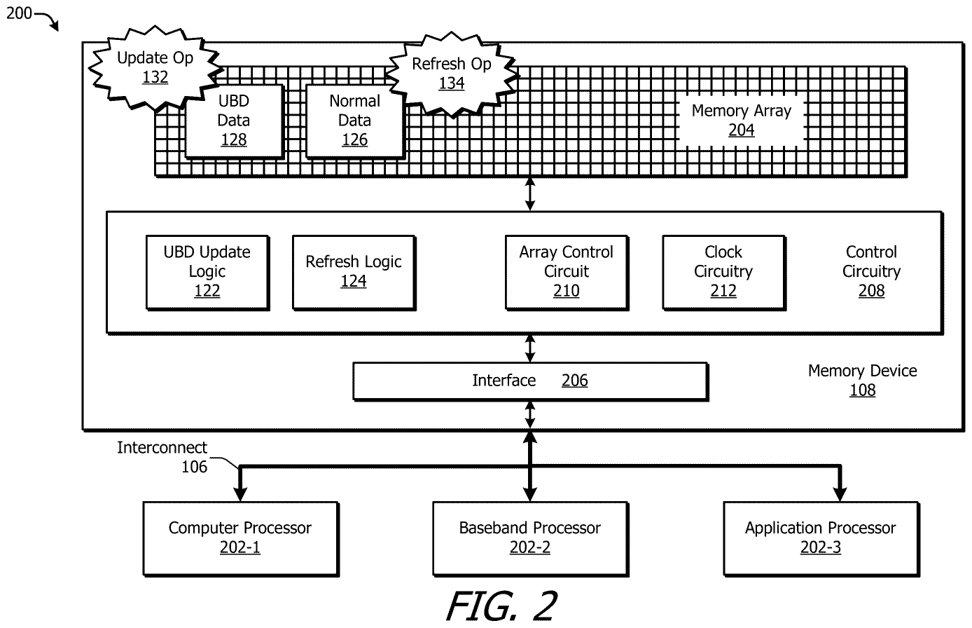

In example implementations, the memory device 108 includes at least one instance of usage-based-disturbance update logic 122 (UBD update logic 122) and at least one instance of refresh logic 124. Each instance of logic can be implemented using software, firmware, hardware, fixed logic circuitry, or some combinations thereof. Generally, the logic can be realized with circuitry. This logic can be arranged or organized in any manner. For example, two or more instances of logic can be combined, or one logic instance may incorporate or encompass at least a portion of one or more other logic instances. For instance, all or a portion of the UBD update logic 122 and the refresh logic 124 can be combined as control circuitry (e.g., of FIG. 2) of the memory device 108.

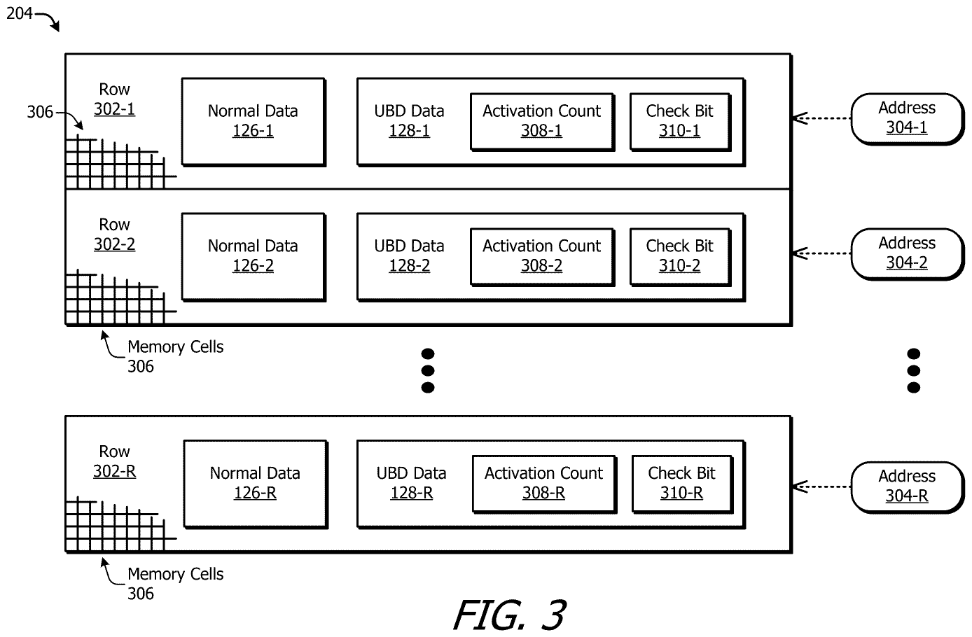

The memory device 108 includes at least one memory array (e.g., as shown in FIGS. 2 and 3 and described below) to store data. The memory device 108 can store, for example, normal data 126 and usage-based-disturbance data 128 (UBD data 128) in the memory array. The normal data 126 includes data that an external device, such as the memory controller 114, can access via the memory array (e.g., excluding memory registers). The memory controller 114 can store normal data 126 into the memory array of the memory device 108 and retrieve the normal data 126 from the memory array. Normal data 126 may include, for instance, user data of the host device 104. The UBD data 128 includes data that the memory device 108 generates, collects, manipulates, or otherwise uses to combat the effects of usage-based disturbance. Examples of normal data 126 and UBD data 128 are described further below with reference to FIG. 3.

In example operations, the refresh logic 124 controls the refreshing of DRAM cells using at least one refresh operation 134 (“refresh op 134”) to ensure data is not lost due to capacitor discharge. The DRAM refreshing can be performed responsive to externally generated refresh commands (e.g., from the memory controller 114) or internally generated refresh commands. In some cases, the refresh logic 124 determines currently available timing resources that can be confiscated (e.g., appropriated, commandeered, or stolen). For example, instead of performing a refresh operation 134, the memory device 108 can perform at least one UBD mitigation operation during a confiscated refresh opportunity. A UBD mitigation operation can include detecting a condition associated with usage-based disturbance, such as the presence of an aggressor row, or initiating a refresh of one or more victim rows associated with the detected condition of the aggressor row. The refresh operation 134 can be applied, for instance, to one or more rows storing normal data 126.

During the performance of memory read or write operations for the host device 104, the memory device accesses a row of data. The accessing entails activating the row of data. When the memory device 108 has completed accessing the row, the memory device 108 performs a precharge operation on the row to close the row. Responsive to or in conjunction with the precharge operation, the UBD update logic 122 can perform an update operation 132 (“update op 132”) on the UBD data 128 corresponding to the row being closed. The update operation 132 changes the UBD data 128 to reflect another access to the corresponding row. The UBD update logic 122 can, for instance, increment an access count that is stored as part of the UBD data 128. Example realizations of the UBD data 128 and example implementations of the update operation 132 and the refresh operation 134 are further described below, starting with reference to FIG. 3. Next, however, other components of the memory device 108 are described with reference to FIG. 2 in the context of an example computing system.

FIG. 2 illustrates examples of a computing system 200 that can implement aspects of enabling efficient usage-based-disturbance mitigation. In some implementations, the computing system 200 includes at least one memory device 108, at least one interconnect 106, and at least one processor 202. The memory device 108 can include, or be associated with, at least one memory array 204, at least one interface 206, and at least one instance of control circuitry 208 that is operatively coupled to the memory array 204. The control circuitry 208 can be realized as periphery circuitry or central circuitry, including periphery circuitry and central circuitry in accordance with a permitted herein, but optional, interpretation of the word “or” as an “inclusive-or” term.

The memory array 204 can include an array of memory cells, including but not limited to memory cells of DRAM, SDRAM, three-dimensional (3D) stacked DRAM, DDR memory, LPDDR SDRAM, and so forth. The memory array 204 and the control circuitry 208 may be components on a single semiconductor die or on separate semiconductor dies. The memory array 204 or the control circuitry 208 may also be distributed across multiple dies. This control circuitry 208 may additionally or alternatively manage traffic on a bus that is separate from the interconnect 106.

The control circuitry 208 can include various components that the memory device 108 can use to perform various operations. These operations can include communicating with other devices, managing memory performance, performing refresh operations (e.g., self-refresh operations or auto-refresh operations), and performing memory read or write operations. In the depicted configuration, the control circuitry 208 includes at least one instance of the UBD update logic 122, at least one instance of the refresh logic 124, at least one array control circuit 210, and at least one instance of clock circuitry 212. In some implementations, the UBD update logic 122 and the refresh logic 124 are part of the control circuitry 208, as shown in FIG. 2. In other implementations, the UBD update logic 122, the refresh logic 124, or some combination thereof are considered at least partly separate from the control circuitry 208 from a logical or physical perspective.

The array control circuit 210 can include circuitry that provides command decoding, address decoding, input/output functions, amplification circuitry, power supply management, power control modes, and other functions. The clock circuitry 212 can synchronize various memory components with one or more external clock signals provided over the interconnect 106, including a command-and-address clock or a data clock. The clock circuitry 212 can also include an internal clock generator or use an internal clock signal to synchronize memory components. The clock circuitry 212 may further provide timer functionality.

The UBD update logic 122, which may be part of UBD mitigation logic (not shown), can be coupled to a set of memory cells within the memory array 204 that store the usage-based-disturbance data 128 (UBD data 128). The UBD data 128 can include information such as an activation count, which represents a quantity of times one or more rows within the memory array 204 have been activated (or accessed) by the memory device 108. In example implementations, each row of the memory array 204 includes a subset of memory cells that stores the UBD data 128 associated with that row, as is further described with reference to FIG. 3. Each row of the memory array 204 can also include memory cells that store the normal data 126. In example operations, the refresh logic 124 performs refresh operations 134 on DRAM cells to ensure data (e.g., the normal data 126) is not lost. The UBD update logic 122 can perform update operations 132 on the UBD data 128.

The interface 206 can couple the control circuitry 208 or the memory array 204 directly or indirectly to the interconnect 106. In some implementations, the UBD update logic 122, the refresh logic 124, the array control circuit 210, and the clock circuitry 212 can be part of a single component (e.g., the control circuitry 208). In other implementations, one or more of the UBD update logic 122, the refresh logic 124, the array control circuit 210, or the clock circuitry 212 may be implemented as separate components, which can be provided on a single semiconductor die or disposed across multiple semiconductor dies. In some cases, at least part of the UBD update logic 122 and the refresh logic 124 can be combined into joint circuitry that operates to support refresh functionality and usage-based-disturbance functionality. Any of these components may individually or jointly couple to the interconnect 106 via the interface 206.

The interconnect 106 may use one or more of a variety of interconnects that communicatively couple together various components and enable commands, addresses, or other information or data to be transferred between two or more components (e.g., between the memory device 108 and a processor 202). Although the interconnect 106 is illustrated with a single line in FIG. 2, the interconnect 106 may include at least one bus, at least one switching fabric, one or more wires or traces that carry voltage or current signals, at least one switch, one or more buffers, and so forth. Further, the interconnect 106 may be separated into at least a command-and-address bus and a data bus.

In some aspects, the memory device 108 may be a “separate” component relative to the host device 104 (of FIG. 1) or any of the processors 202. The separate components can include a printed circuit board (PCB), memory card, memory stick, memory module (e.g., a single in-line memory module (SIMM), dual in-line memory module (DIMM), or Compute Express Link® (CXL®) memory module), or memory integrated circuit, just to name a few examples. Separate physical components may be located together within the same housing of an electronic device or may be distributed over a server rack, a data center, and so forth. Alternatively, the memory device 108 may be integrated with other physical components, including the host device 104 or the processor 202, by being mounted together on a PCB or by being combined in a single package or a system-on-chip.

As shown in FIG. 2, the processors 202 may include a computer processor 202-1, a baseband processor 202-2, and an application processor 202-3, which are coupled to the memory device 108 through the interconnect 106. The processors 202 may include or form a part of a central processing unit (CPU), a graphics processing unit (GPU), a system-on-chip (SoC), an application-specific integrated circuit (ASIC), a field-programmable gate array (FPGA), and so forth. In some cases, a single processor can comprise multiple processing resources, each dedicated to different functions (e.g., modem management, applications, graphics, central processing). In some implementations, the baseband processor 202-2 may include or be coupled to a modem (not illustrated in FIG. 2) and referred to as a modem processor. The modem or the baseband processor 202-2 may be coupled wirelessly to a network via, for example, cellular, Wi-Fi®, Bluetooth®, near field, or another technology or protocol for wireless communication.

In some implementations, the processors 202 may be connected directly to the memory device 108 (e.g., via the interconnect 106). In other implementations, one or more of the processors 202 may be indirectly connected to the memory device 108 (e.g., over a network connection or through one or more other devices). Examples of the memory array 204 with the normal data 126 and the UBD data 128 are further described next with reference to FIG. 3.

### Example Techniques and Hardware

FIG. 3 is a schematic diagram illustrating example approaches to storing normal data 126 and usage-based-disturbance data 128 within rows 302 of a memory array 204 to support usage-based-disturbance mitigation, including to support efficient implementations of usage-based-disturbance data as described herein. As illustrated, the memory array 204 includes multiple rows 302 of memory cells 306. For example, the memory array 204 can include multiple rows 302-1, 302-2, . . . , 302-R, where R represents a positive integer. Each row 302 is respectively associated with an address 304 (e.g., a row address, a memory row address, or a memory address) of multiple addresses 304-1, 304-2, . . . , 304-R. For example, a first row 302-1 has a first address 304-1, a second row 302-2 has a second address 304-2, and an R^{th} row 302-R has an R^{th} address 304-R.

In example implementations, each of the rows 302 can store normal data 126 and usage-based-disturbance data 128. For instance, each of the rows 302 can store normal data 126 within a first subset of the memory cells 306 associated with that row 302. The normal data 126 represents data that is read from or written to the memory device 108 during normal memory input/output operations (e.g., during normal read or write operations for user data). The normal data 126 can include, for example, data that is transmitted by the memory controller 114 and is written to one or more rows 302 of the memory array 204. The normal data 126 can exclude data that is written to, or read from, a memory register. In some implementations, in addition to the normal data 126, each of the rows 302 can store usage-based-disturbance data 128. The usage-based-disturbance data 128 can be stored within a second subset of the memory cells 306 associated with that row 302. The first and second subsets of the memory cells 306 can have the same characteristics or different ones, as is described herein. In alternative implementations, the usage-based-disturbance data 128 can be stored separately from the rows 302. The usage-based-disturbance data 128 includes information that enables usage-based-disturbance mitigation logic (not shown) to mitigate the potential effects of usage-based disturbance, which effects are described next.

To meet the demands for physically smaller memories, memory devices can be designed with higher chip densities for the memory cells 306 of a memory array 204. Increasing chip density, however, can increase the electromagnetic coupling between the memory cells 306 of proximate rows 302 due, at least in part, to a shrinking distance between these rows 302. With this undesired electromagnetic coupling (e.g., capacitive coupling), activation (or charging) of a first row 302-X (not explicitly shown) of the memory cells 306 can sometimes negatively impact the integrity of the digital values stored in a second nearby row of memory cells 306, such as a row 302-(X+1) or a row 302-(X−1). This phenomenon is referred to as usage-based disturbance herein. Activation of the first row 302-X can generate interference, or crosstalk, that causes the second row, say 302-(X+1), to experience a voltage fluctuation. In some instances, this voltage fluctuation can cause a state, or value, of a memory cell 306 in the second row 302-(X+1) to be incorrectly determined by a sense amplifier. Consider an example in which a state of a memory cell 306 in the second row 302-(X+1) is a logical “1” (e.g., a high voltage). In this example, the voltage fluctuation can cause a sense amplifier to incorrectly determine the state of the memory cell 306 in the second row 302-(X+1) to be a logical “0” (e.g., a low voltage) instead of a logical “1.” Left unchecked, this interference can lead to memory errors or data loss within the memory device 108.

In some circumstances, a particular row 302-X of memory cells 306 is activated repeatedly in an unintentional manner or in an intentional manner, which intentionality can be part of a malicious act. Such a row 302-X that is repeatedly activated is referred to herein as an aggressor row. Consider, for instance, that memory cells 306 in a Zth row are subjected to repeated activation, which causes one or more memory cells 306 in a proximate row (e.g., an adjacent row) to change states. Here, a proximate row can include another row within a Z+1 row, which is an adjacent row; within a Z+2 row; within a Z−1 row, which is another adjacent row; and/or within a Z−2 row. These proximate rows, which number four in this example, are referred to herein as victim rows. The “+1” and “−1” refer to the next row to be refreshed by temporal or physical order and the previous row that was refreshed by temporal or physical order, respectively, and not necessarily to the row address that is mathematically incremented and decremented by one, respectively.

The occurrence of usage-based disturbance can lead to the corruption or changing of contents within the affected row(s) 302 of memory. To combat the negative effects of usage-based disturbance, usage-based-disturbance mitigation logic of a memory device 108 can perform usage-based-disturbance mitigation operations. For example, the usage-based-disturbance mitigation logic can refresh one or more proximate rows 302, or at least one adjacent row 302, to recharge the capacitors that store the voltages that represent data. In other words, performing a refresh operation on a row 302 returns the memory cells 306 to their “full” correct charges. If the refresh operation is performed in a timely manner on a victim row, data loss because of usage-based-disturbance can be prevented. Whether a refresh operation on a victim row is timely can be determined, at least probabilistically, based on a quantity of activations of a corresponding aggressor row.

In some implementations, the usage-based-disturbance data 128 includes an activation count 308. With the activation count 308, the memory device 108 can keep track of the quantity of accesses or activations of the corresponding memory row 302. In example aspects, the usage-based-disturbance data 128 can also include a count of how many times a neighboring row (e.g., an adjacent or other proximate row) is refreshed in order to mitigate usage-based disturbance. Each of these counts provides an example mechanism by which the usage-based-disturbance mitigation logic can monitor for usage-based disturbance and determine when to refresh victim rows to reduce the risk of usage-based disturbance corrupting data in the victim rows.

In the example shown in FIG. 3, the first row 302-1 stores first normal data 126-1 within a first subset of memory cells 306 of the first row 302-1 and stores first usage-based-disturbance data 128-1 within a second subset of memory cells 306 of the first row 302-1. The first usage-based-disturbance data 128-1 includes a first activation count 308-1, which represents a quantity of times the first row 302-1 has been activated since a last refresh or other initialization or resetting/clearing of the activation count. As another example, the second row 302-2 stores second normal data 126-2 within a first subset of memory cells 306 within the second row 302-2 and stores second usage-based-disturbance data 128-2 within a second subset of memory cells 306 within the second row 302-2. The second usage-based-disturbance data 128-2 includes a second activation count 308-2, which represents a quantity of times the second row 302-2 has been activated since a last refresh.

Additionally, the R^{th} row 302-R stores R^{th} normal data 126-R within a first subset of memory cells 306 within the R^{th} row 302-R and stores R^{th} usage-based-disturbance data 128 -R within a second subset of memory cells 306 within the R^{th} row 302-R. The R^{th} usage-based-disturbance data 128-R includes an R^{th} activation count 308-R, which represents a quantity of times the R^{th} row 302-R has been activated since a last refresh. The first subset of memory cells 306 and the second subset of memory cells 306 may have the same or different characteristics. Alternatively, the normal data 126 and the UBD data 128 may be located in a common subset of memory cells 306, or the memory array 204 may lack different or multiple subsets of memory cells 306.

The usage-based-disturbance data 128 can also include information to support error detection or can be formatted (e.g., coded) in such a way as to support error detection. In this example, the usage-based-disturbance data 128 includes at least one check bit 310, such as a parity bit. In particular, the usage-based-disturbance data 128-1, 128-2, . . . , 128-R respectively includes a check bit 310-1, 310-2, . . . , 310-R. The at least one check bit 310 can be used to perform, for instance, an error-correcting-code (ECC) operation. Other implementations are also possible in which the usage-based-disturbance data 128 is coded in a manner that supports any given error detection test, such as an ECC check. Thus, the at least one check bit 310, such as one or more parity bits, that are stored as part of the usage-based-disturbance data 128 can be used to check the accuracy or correctness of the activation count 308 or to check the accuracy or correctness of other parts of the usage-based-disturbance data 128.

To protect against data loss because of usage-based-disturbance effects, refresh operations can be performed based on values stored as the activation counts 308. For example, the usage-based-disturbance mitigation logic can determine whether a victim row 302 is to be refreshed using an activation count 308 of an aggressor row 302 and at least one mitigation threshold (not shown). If the activation count 308 exceeds the mitigation threshold, then the usage-based-disturbance mitigation logic causes a refresh operation to be performed on the victim row or rows 302. For instance, the usage-based-disturbance mitigation logic can queue the victim row 302 for refreshing due to usage-based disturbance. The refresh operation may be performed by the refresh logic 214 or by logic associated with usage-based-disturbance mitigation.

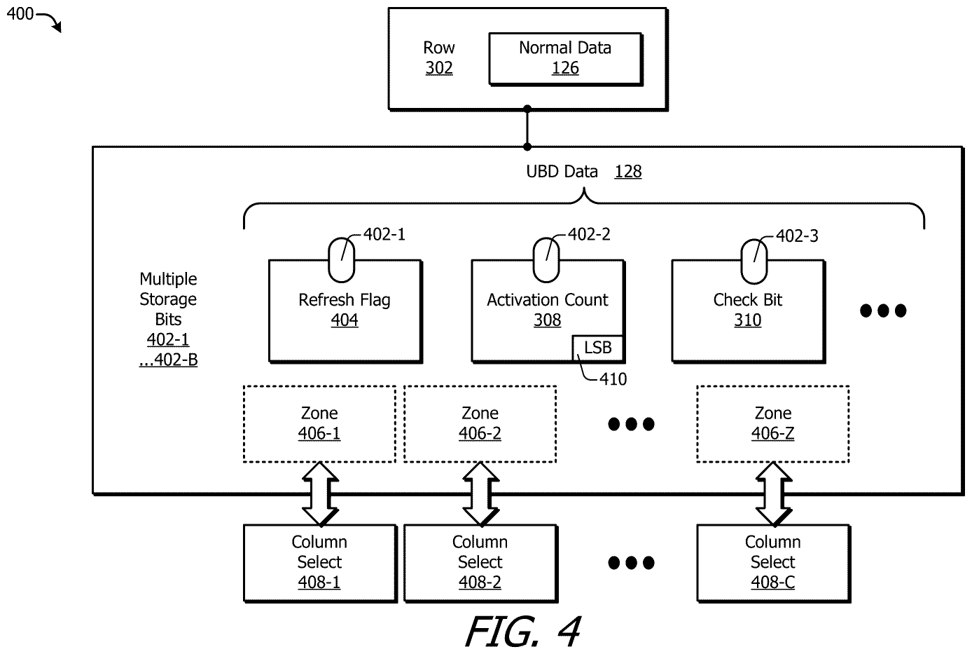

FIG. 4 is a schematic diagram 400 illustrating multiple storage bits 402 that can hold example implementations of usage-based-disturbance data 128 for enabling efficient usage-based-disturbance mitigation. FIG. 4 depicts a row 302 that includes normal data 126. The usage-based-disturbance data 128 is associated with the row 302. As described above, the UBD data 128 may be stored as part of the row 302. The schematic diagram 400 includes multiple storage bits 402-1, 402-2, 402-3, . . . , 402-B, with B representing an integer greater than one.

In example implementations, each storage bit 402 can store a bit of data that corresponds to a type of information. For example, a first storage bit 402-1 can store a refresh flag 404. The refresh flag 404 is indicative of a refresh status of the row 302 of normal data 126. In some cases, a refresh flag 404 can include more than one storage bit 402. A second storage bit 402-2 can store a bit of the activation count 308, which count includes multiple bits and corresponds to the row 302 of the normal data 126. An example bit of the activation count 308 is the least significant bit 410 (LSB 410) of the activation count 308. A third storage bit 402-3 can store a check bit 310. These storage bits 402, or the information types that the storage bits retain, can be positioned in different orders regardless of the numeric indications (e.g., “first” or “−1”). Examples of various orders or storage-bit layouts are described herein below with reference to FIGS. 5-1 to 5-3.

In example operations, the refresh flag 404 indicates a refresh status of the row 302 of the normal data 126. For example, the refresh status can be set to be affirmative responsive to the row 302 being refreshed. The affirmative setting can be maintained, for instance, until the row 302 is accessed for a normal read or write request. To facilitate certain operations, the multiple storage bits 402-1 . . . 402-B can be separated into multiple zones 406-1, 406-2, . . . , 406-Z, with Z representing an integer greater than one. Each zone 406 of the multiple zones 406-1 . . . 406-Z includes or forms a subset of storage bits of the multiple storage bits 402-1 . . . 402-B.

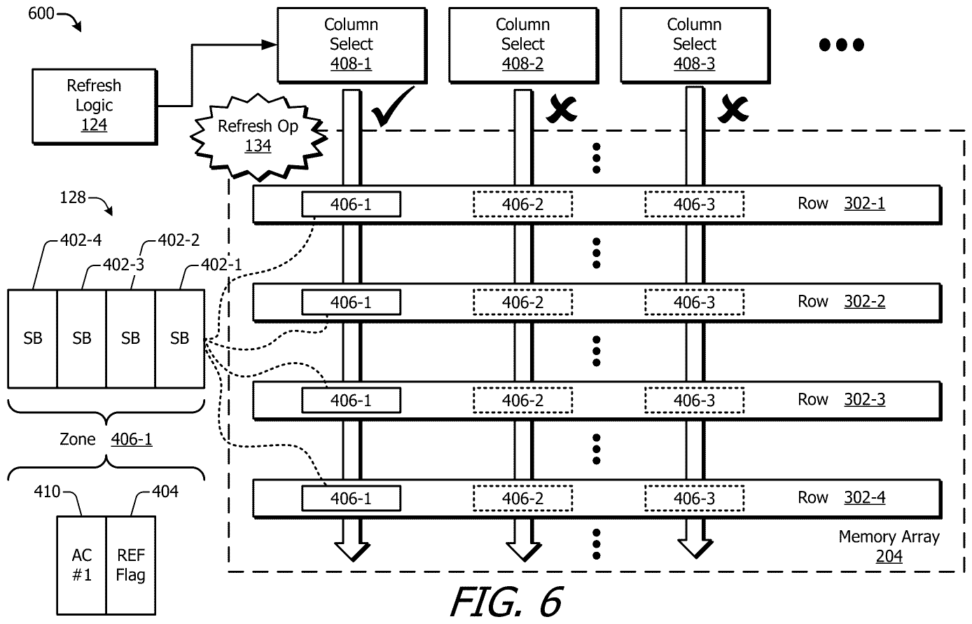

The control circuitry 208 (e.g., of FIG. 2) of a memory device 108, such as an array control circuit 210 of the control circuitry 208, can include multiple column selects 408-1, 408-2, . . . , 408-C, with C representing an integer greater than one. In some cases, the variables Z and C can have the same value. Each respective column select 408 of the multiple column selects 408-1 . . . 408-C is coupled to a respective zone 406 of the multiple zones 406-1 . . . 406-Z. Example schemes for accessing the multiple zones 406-1 . . . 406-Z using the multiple column selects 408-1 . . . 408-C are described below with reference to FIG. 6.

In some implementations, a first zone 406-1 of the multiple zones 406-1 . . . 406-Z includes the first storage bit 402-1 and the second storage bit 402-2. The first storage bit 402-1 is configured to store the refresh flag 404, and the second storage bit 402-2 is configured to store the LSB 410 of the activation count 308. If more-significant bits of the activation count 308 are part of a different zone 406 that is coupled to a different column select 408, the refresh flag 404 can be accessed independently of the most-significant bit of the activation count 308. Examples of such bit arrangements are described next with reference to FIGS. 5-1 to 5-2.

FIGS. 5-1, 5-2, and 5-3 are block diagrams 500-1, 500-2, and 500-3, respectively, illustrating example implementations for different bit assignments for the multiple storage bits 402-1 . . . 402-B of the usage-based-disturbance data 128 of FIG. 4. In these illustrated examples, there are 16 storage bits (“SB”) 402-1, 402-3, 402-3, . . . , 402-14, 402-15, and 402-16 (e.g., B=16). These 16 storage bits 402-1 . . . 402-16 are separated into four zones (e.g., Z=4): a first zone 406-1, a second zone 406-2, a third zone 406-3, and a fourth zone 406-4. Other implementations, however, can have different quantities of storage bits 402 or zones 406. Here, each zone 406 includes the same quantity of four storage bits 402. In other cases, different zones 406 may include differing quantities of storage bits 402.

Each column select 408 is respectively coupled to a zone 406. Thus, each column select 408 is coupled to four storage bits 402 in the illustrated examples. A first column select 408-1 is coupled to the first zone 406-1 and the four storage bits 402 thereof. A second column select 408-2 is coupled to the second zone 406-2 and the four storage bits 402 thereof. A third column select 408-3 is coupled to the third zone 406-3 and the four storage bits 402 thereof. A fourth column select 408-4 is coupled to the fourth zone 406-4 and the four storage bits 402 thereof. By way of example, the first column select 408-1 is coupled to the first storage bit 402-1, the second storage bit 402-2, the third storage bit 402-3, and the fourth storage bit 402-4. Accordingly, the first column select 408-1 can enable access to these four storage bits 402-1 to 402-4 for reading or writing to the contents thereof.

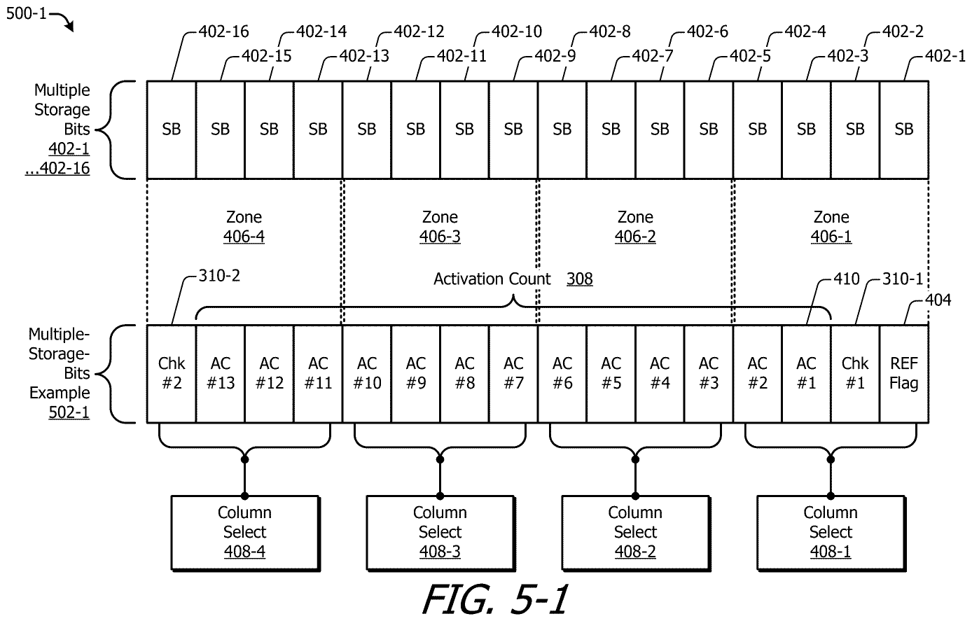

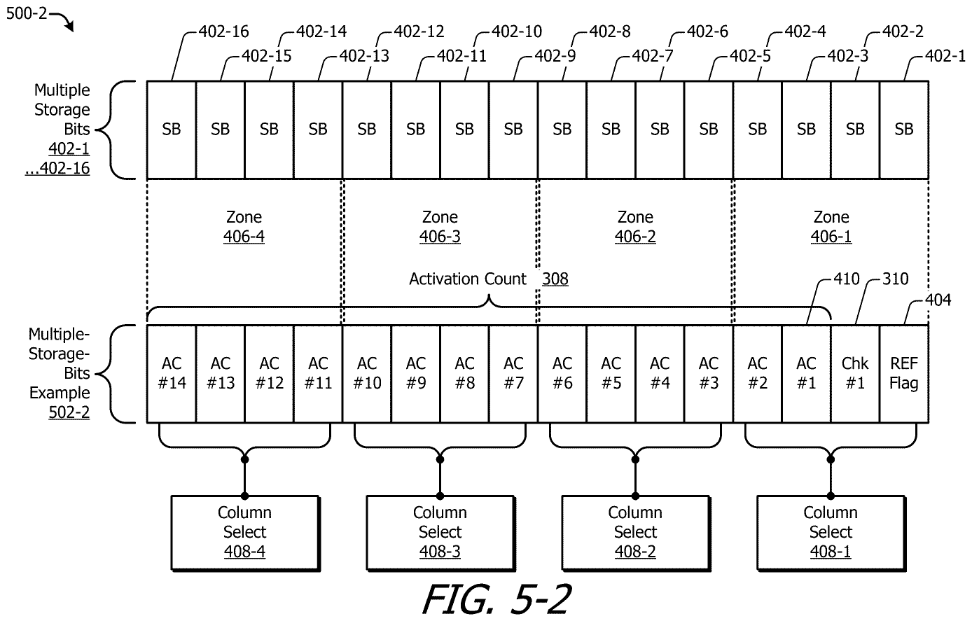

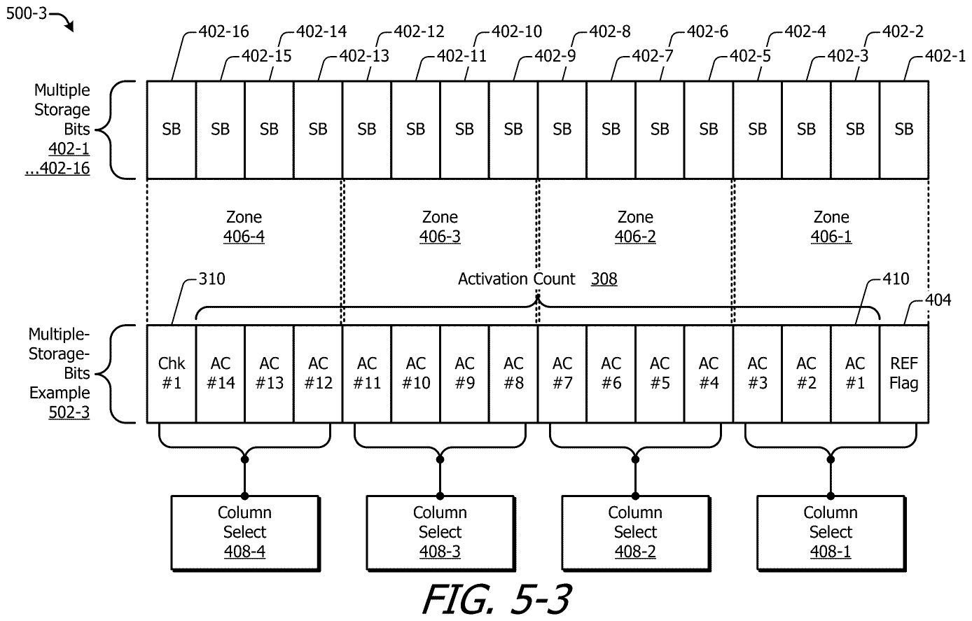

Regarding the example of FIG. 5-1, a first multiple-storage-bits example 502-1 is depicted. The first multiple-storage-bits example 502-1 includes one refresh flag 404 (“REF flag 404”), two check bits 310-1 and 310-2 (“Chk #1” and “Chk #2), and 13 activation count bits (AC #1, AC #2, . . . , AC #12, and AC #13) of the activation count 308. One of these activation count bits, AC #1, is the LSB 410 of the activation count 308. As shown, the refresh flag 404 and the LSB 410 are coupled to the same column select 408, the first column select 408-1 in the illustrated example. The second-most least-significant bit, AC #2, is also coupled to the same first column select 408-1. This enables the refresh flag 404 and the two least significant bits to be changed independently of the other bits of the activation count 308. As described below with reference to FIG. 6, this enables the memory device 108 to save power.

The first multiple-storage-bits example 502-1 includes two check bits 310-1 and 310-2. The first check bit 310-1 is coupled to the first column select 408-1. By including a check bit 310 in the same zone 406 as the refresh flag 404, which same zone 406 is the first zone 406-1 in the example of FIG. 5-1, the storage-bit arrangement enables the remaining three bits of the first zone 406-1 to be checked for accuracy independently of the remaining bits of the first multiple-storage-bits example 502-1. The second check bit 310-2 is coupled to the fourth column select 408-4. The second check bit 310-2 can be used to check the correctness of the 11 activation count bits AC #3 to AC #13. Such a verification operation can be performed if the second, third, and fourth column selects 408-2, 408-3, and 408-4 are accessed together.

Regarding the example of FIG. 5-2, a second multiple-storage-bits example 502-2 is depicted. The second multiple-storage-bits example 502-2 includes one refresh flag 404 (“REF flag 404”), one check bit 310 (“Chk #1”), and 14 activation count bits (AC #1, AC #2, . . . , AC #13, and AC #14) of the activation count 308. One of these activation count bits, AC #1, is the LSB 410 of the activation count 308. Thus, the second multiple-storage-bits example 502-2 is similar to the first multiple-storage-bits example 502-1 of FIG. 5-1.

However, the second check bit 310-2 of FIG. 5-1 is replaced with a 14th activation count bit (AC #14), which is coupled to the fourth column select 408-4. This increases the quantity of row activations that can be tracked by the activation count 308. On the other hand, there is no separate check bit 310 for the multiple storage bits 402-5 . . . 402-16. Consequently, if the multiple storage bits 402-1 . . . 402-4 are accessed and changed separately from the other bits, the error-checking functionality may be temporarily impacted (e.g., rendered ineffective). The error-checking functionality can be reinitialized the next time the four column selects 408-1 to 408-4 are jointly accessed.

Regarding the example of FIG. 5-3, a third multiple-storage-bits example 502-3 is depicted. The third multiple-storage-bits example 502-3 includes one refresh flag 404 (“REF flag 404”), one check bit 310 (“Chk #1”), and 14 activation count bits (AC #1, AC #2, . . . , AC #13, and AC #14) of the activation count 308. One of these activation count bits, AC #1, is the LSB 410 of the activation count 308. Thus, the third multiple-storage-bits example 502-3 is similar to the second multiple-storage-bits example 502-2 of FIG. 5-2. However, the check bit 310 is coupled to the fourth column select 408-4, and there are three activation count bits AC #1 to AC #3 jointly coupled with the refresh flag 404 to the first column select 408-1. With three least significant bits of the activation count 308 impacted in conjunction with changing the refresh flag 404, the amount by which the value of the activation count 308 deviates from the actual count responsive to a change to the refresh flag 404 can be greater for the third multiple-storage-bits example 502-3.

FIG. 6 is a schematic diagram 600 illustrating example techniques for refresh logic 124 to operate column select circuitry as part of a refresh operation 134 in relation to usage-based-disturbance data 128. As illustrated, a memory array 204 includes multiple memory rows 302-1, 302-2, 302-3, and 302-4. Each row 302 includes UBD data 128 (e.g., also of FIGS. 3 to 5-3). In example implementations, the refresh logic 124 performs the refresh operation 134 on multiple rows 302, which number four in this example, substantially simultaneously (e.g., in an at least partially overlapping manner). The UBD data 128 can be realized in any of multiple manners, including as any of the first, second, or third multiple-storage-bits examples 502-1, 502-2, and 502-3.

An example first zone 406-1 includes four storage bits 402-1 . . . 402-4. These four storage bits 402-1 . . . 402-4 include at least a refresh flag 404 and an LSB 410 of the activation count 308. As also shown in FIGS. 4 and 5-1 to 5-3, each respective zone 406 of the UBD data 128 is coupled to a respective column select 408. Although three zones 406-1 to 406-3 and three column selects 408-1 to 408-3 are explicitly shown in FIG. 6, UBD data 128 and associated access circuitry can number more or fewer than three instances. In some implementations, the refresh logic 124 causes fewer than all the column selects 408 that are coupled to the UBD data 128 to access the UBD data 128 as part of the refresh operation 134. For example, the first column select 408-1 accesses the activation count bits of the first zone 406-1, which is represented by the “check mark” under the first column select 408-1. Thus, the refresh flag 404 can be changed using the first column select 408-1.

The other column selects 408-2 and 408-3, in contrast, are not activated by the refresh logic 124, which non-activation is represented by the “x mark” under the second and third column selects 408-2 and 408-3. By omitting activation of, or by refraining from activating, one or more column selects 408, the described techniques save power during each refresh operation 134. For instance, if four column selects 408-1 to 408-4 are used to span the UBD data 128, then seventy-five percent (75%) of the power is saved by activating exactly one of the four column selects 408.

During a refresh operation 134, the refresh logic 124 writes to the first column select 408-1 by setting the refresh flag 404 and placing a determined value (e.g., “0” or “1”) into the LSB 410. For instance, the refresh flag 404 can be set by writing a “1,” and the LSB 410 can be “initialized” by writing a “0” therein. If a check bit 310 is included in the first zone 406-1, then that check bit 310 can also be forced to a determined value (e.g., a known value of “0” or “1”) while the refresh flag 404 is being set. Any other activation count bits of the activation count 308 that are part of the first zone 406-1 may also be initialized to a determined value. However, other activation count bits of the activation count 308 that are stored in other zones 406 of the UBD data 128 are left unchanged by the refresh operation 134 if the refresh logic 124 refrains from activating other column selects 408 besides the first column select 408-1. Accordingly, these other more-significant bits of the activation count 308 continue to reflect a current quantity of activations of the corresponding row 302, even if the current quantity becomes “slightly” inaccurate after one or more least significant bits of the activation count 308 are changed in conjunction with the setting of the refresh flag 404. The relatively small percentage change to the activation count 308 by changing at least one LSB need not jeopardize an overall usage-based-disturbance mitigation strategy that uses, e.g., 13-14 activation count bits for the activation count 308.

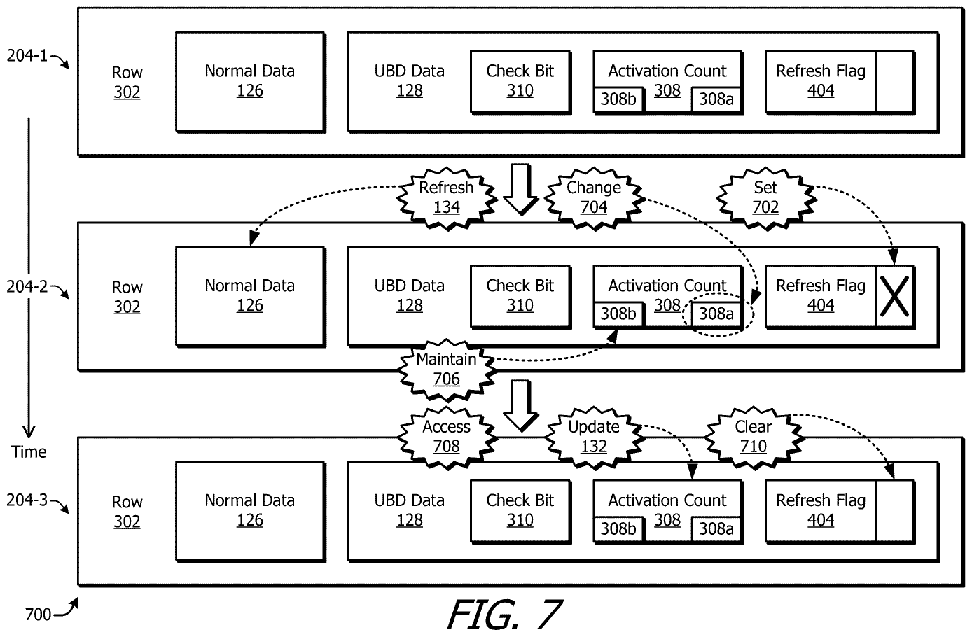

FIG. 7 is a schematic diagram 700 illustrating example techniques for performing a refresh operation 134 and an update operation 132 on normal data 126 or usage-based-disturbance data 128 that are stored in a row 302 of a memory array 204. In FIG. 7, time elapses in the downward direction. Thus, the memory array 204-1 represents a state of the row 302 at a first time, and the memory array 204-2 represents a state of the row 302 at a second, subsequent time. Further, the memory array 204-3 represents a state of the row 302 at a third time that occurs after the second time.

In the illustrated example, the row 302 includes the UBD data 128 that corresponds to the normal data 126. The UBD data 128 includes at least one check bit 310, at least one activation count 308, and at least one refresh flag 404. The activation count 308 includes at least two portions 308a and 308b. In some cases, each portion 308a or 308b of the activation count 308 includes at least one zone 406 (e.g., of FIGS. 4 to 6) of the UBD data 128.

In example implementations, to transition from the first time for the memory array 204-1 to the second time for the memory array 204-2, the control circuitry 208 (e.g., of FIG. 2) performs a refresh operation 134 on the row 302. The refresh operation 134 can entail refreshing the charges stored in the memory cells 306 for the normal data 126. In conjunction with, or as part of the refresh operation 134, the control circuitry 208 also sets 702, as represented by the large “X,” the refresh flag 404 of the usage-based-disturbance data 128. The set status of the refresh flag 404 can indicate that the row 302 has been refreshed based on performance of the refresh operation 134 on the row 302.

The control circuitry 208 may also change 704 at least a portion 308a of the activation count 308, with the portion 308a being part of a zone 406 (e.g., a first zone 406-1) that includes the refresh flag 404. This portion 308a may include, for instance, an LSB 410 (e.g., of FIGS. 4 to 5-3) of the activation count 308. After the refresh operation 134 is completed, and after the refresh flag 404 has been set 702, the control circuitry 208 maintains 706 at least a portion 308b of the activation count 308 in an unchanged state based on the performance of the refresh operation 134 on the row 302. For example, the bits of the activation count 308 that are part of other zones 406 (e.g., second through fourth zones 406-2 to 406-4) that do not include the refresh flag 404 can be left unchanged after the refresh operation 134 that sets the refresh flag 404.

In some implementations, the control circuitry 208 sets 702 the refresh flag 404 of the usage-based-disturbance data 128 to indicate that the row 302 has been refreshed by activating a first column select 408-1 (e.g., of FIGS. 4 to 6) of multiple column selects 408-1 . . . 408-4 (e.g., of FIGS. 4 to 6 with C being four) that correspond to the usage-based-disturbance data 128. Here, the first column select 408-1 is coupled to the refresh flag 404. The control circuitry 208 also maintains 706, after the activating of the first column select 408-1 is concluded (e.g., after the first column select 408-1 has been deactivated), at least the portion 308b of the activation count 308 in the unchanged state by omitting activation of a second column select 408-2 of the multiple column selects 408-1 . . . 408-4 that correspond to the usage-based-disturbance data 128. Here, the second column select 408-2 is coupled to at least part of the portion 308b, and the first column select 408-1 is different from the second column select 408-2.

The second column select 408-2 can be coupled to multiple storage bits 402 of the activation count 308. In some cases, the second column select 408-2 may also be coupled to at least one check bit 310 of the usage-based-disturbance data 128 (e.g., may be coupled to the second check bit 310-2 of FIG. 5-1 or the check bit 310 of FIG. 5-3). Additionally or alternatively, the first column select 408-1 can be coupled to at least one check bit 310 of the usage-based-disturbance data 128 (e.g., can be coupled to the first check bit 310-1 of FIG. 5-1 or the check bit 310 of FIG. 5-2). In some cases, the control circuitry 208 can store a determined value (e.g., a predetermined or known value of “0” or “1”) in the at least one check bit 310 based on at least one of setting 702 the refresh flag 404 or the performance of the refresh operation 134 on the row 302.

Additionally or alternatively, the first column select 408-1 can be coupled to at least one storage bit 402 of the activation count 308 corresponding to the row 302. In at least some of such cases, the at least one storage bit 402 of the activation count 308 (e.g., a second storage bit 402-2 of the UBD data 128) includes a least significant bit (LSB) 410 of the activation count 308 corresponding to the row 302.

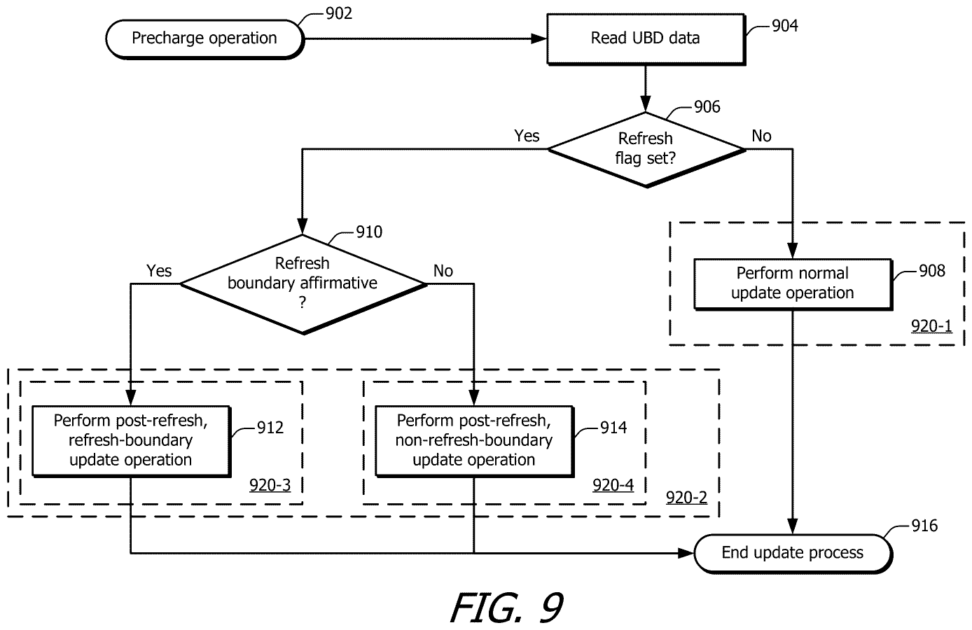

In example implementations, to transition from the second time of the memory array 204-2 to the third time of the memory array 204-3, the control circuitry 208 determines that the row 302 is being accessed 708 for a memory read or write request. Responsive to a determination that the row 302 is being accessed for the memory request, the control circuitry 208 updates 132 (or performs an update operation 132 on) the activation count 308 using an operation that depends on the refresh status of the refresh flag 404. If the refresh flag 404 is not set, then a first update operation may be performed. If, on the other hand, the refresh flag 404 is set, then a second update operation may be performed. A version of the second update operation may entail clearing 710 the refresh flag 404. Example techniques to handle memory-request accesses, which techniques can be initiated in response to a precharge operation, to the row 302 are described below with reference to FIG. 9.

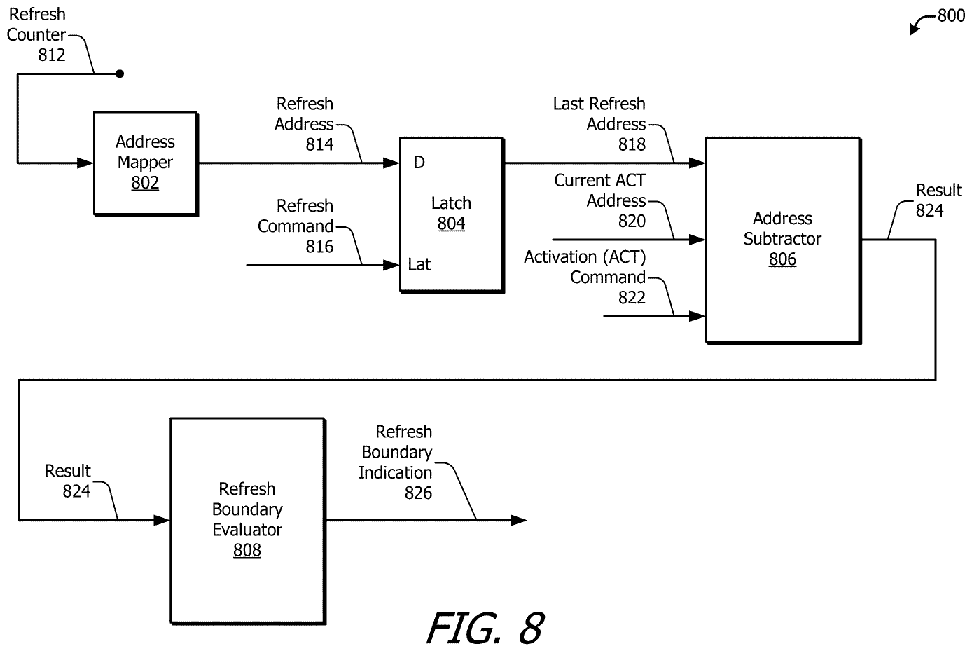

FIG. 8 is a schematic diagram 800 illustrating example techniques for a usage-based-disturbance mitigation circuit to determine a refresh boundary. The refresh boundary can be used as part of the process to update usage-based-disturbance data in conjunction with a memory access operation, which updating is described below with reference to FIG. 9. A usage-based-disturbance mitigation circuit can be part of the control circuitry 208 (of FIG. 2) as is described with reference to FIG. 3. As illustrated, the usage-based-disturbance mitigation circuit can include at least one address mapper 802, at least one latch 804, at least one address subtractor 806, and at least one refresh boundary evaluator 808.

In example implementations, the address mapper 802 receives a refresh counter 812 corresponding to a row 302 (e.g., of FIG. 3) that is targeted by a refresh operation. The address mapper 802 maps (e.g., converts using a table, formula, or algorithm) the refresh counter 812 to a refresh address 814. The addresses of FIG. 8 can correspond, for example, to row addresses or a portion thereof. The address mapper 802 provides the refresh address 814 to the data input (“D”) of the latch 804. The clock or latching input (“Lat”) of the latch 804 receives a refresh command 816. The refresh command 816, which can be internally generated or received at the memory device 108 from an external source, triggers performance of a refresh operation 134 (e.g., of FIGS. 1, 6, and 7).

The latch 804 stores the refresh address 814 between refresh commands. Consequently, responsive to the refresh command 816 triggering the latch 804, the latch 804 forwards the refresh address 814 as the last refresh address 818 (e.g., the row address that was most-recently refreshed or a refresh address of a most-recent refresh operation) to the address subtractor 806 as one input. The address subtractor 806 also receives a current activation address 820 (“current ACT address 820”) as another input. The address subtractor 806 operates in response to receiving an activation (ACT) command 822 targeting a row 302 for a memory read or memory write access operation. The address subtractor 806 subtracts one input from another input to find a difference between the two address inputs. For example, the address subtractor 806 can subtract the last refresh address 818 from the current activation address 820. Here, a result 824 that is output from the address subtractor 806 represents the difference between the two row addresses.

The refresh boundary evaluator 808 receives the result 824 from the address subtractor 806 and generates a refresh boundary indication 826. The refresh boundary indication 826 is indicative of whether a refresh operation is temporally proximate for the row 302 being accessed with the current activation command 822. The operation to update the UBD data 128 can be based on whether the refresh operation is temporally proximate. The refresh operation for the current activation address 820 can be temporally proximate if the refresh operation just occurred or is to occur in the near future, as is described below with reference to FIG. 9. A refresh-distance proximity can be determined based on how many zero or more refresh operations are to occur between the time of the activation command 822 and the refreshing of the row 302 that is targeted by the activation command 822, which is for the current activation address 820.

In some cases, the refresh boundary indication 826 can be a Boolean variable that indicates whether the current activation address 820 was just refreshed. If so, the difference result 824 is zero corresponding to an address match. In other cases, the refresh boundary indication 826 can include multiple bits to cover multiple refresh-boundary distances. For instance, the refresh boundary indication 826 can indicate if there is a one-address difference. Additionally or alternatively, the refresh boundary indication 826 can indicate if there is a two-address difference. Here, the one-address difference and the two-address difference can refer to addresses that are being refreshed in the refresh counter order, and not necessarily to two addresses that differ from each other by one or two, respectively.

The following is a table describing an example approach to implementing the operations of the address subtractor 806 and the refresh boundary evaluator 808 with a two-bit refresh boundary indication 826.

TABLE

| | Two-Bit | |
|---|---|---|
| | Refresh | |
| Result 824 | Boundary | Description |
| (e.g., Address | Indication | (e.g., Refresh |
| Difference) | 826 | Distance) |
| 0 | 00 | Match |
| 1 | 01 | +1 |
| 2 | 10 | +2 |
| Else | 11 | <0 or >2 |

The table can be adjusted or the difference determination can be adjusted to ensure that the refresh-address order is properly reflected in the process. The “+1,” for instance, corresponds to a next refresh operation and not necessarily to a mathematical difference between two addresses of a positive one. The operations can, therefore, be implemented differently. For example, there can be more or fewer categories of refresh distances.

The refresh boundary analysis can be implemented in alternative manners to determine a refresh boundary indication 826. For example, the address subtractor 806 can be replaced with alternative circuitry that counts upward or increments an address and then performs one or more comparison operations to determine if the values are equal. With three comparison operations, a first operation can compare the current activation address 820 to the last refresh address 818 to determine if there is match. A second operation can compare a once-incremented version of the current activation address 820 to the last refresh address 818 to determine if there is a “+1” relationship. A third operation can compare a twice-incremented version of the current activation address 820 to the last refresh address 818 to determine if there is a “+2” relationship. The last refresh address 818 can alternatively be implemented with this comparison-based approach.

### Example Methods

This section describes example methods for implementing aspects of enabling efficient usage-based-disturbance mitigation with reference to the diagrams of FIGS. 9-11. This description may also refer to components, entities, and other aspects depicted in FIGS. 1-8 by way of example only. The described methods are not necessarily limited to performance by one entity or multiple entities operating on one device.

FIG. 9 illustrates an example method 900 for efficiently updating usage-based-disturbance data in conjunction with a memory access operation. As shown, the method 900 can include eight blocks 902-916. In some cases, operations of the method 900 are implemented by a memory device 108 as described with reference to FIGS. 1 and 2. In particular, the operations of the method 900 can be performed by the control circuitry 208 of FIG. 2, including the UBD update logic 122.

In example implementations, at block 902, a precharge operation is performed on a row 302 to close the row 302. At block 904, the UBD update logic 122 reads UBD data 128. At 906, the UBD update logic 122 determines if the refresh flag 404 of the UBD data 128 is set. If not, then this means that the row 302 has not been refreshed since the UBD data 128 was previously updated (e.g., in response to a previous precharge operation). Because the refresh flag 404 has a cleared status, the UBD update logic 122 performs a first type of update operation 920-1. In this case, the UBD update logic 122 performs a normal update operation at block 908. An error check or data verification operation can be performed based on at least one check bit 310. Further, the activation count 308 is incremented, such as by one or another designated increment value. The UBD update logic 122 can omit clearing/resetting the refresh flag 404 because the refresh flag 404 has a cleared status. After block 908, the update process for this row 302 for this accessing round can end at block 916.

If, on the other hand, the refresh flag 404 is determined to be set at block 906, then this is the first access of the row 302 since the refresh operation was most recently performed. By taking the “Yes” branch from block 906 because the refresh flag is set, the UBD update logic 122 performs a second type of update operation 920-2. By way of example, with the second type of update operation 920-2, the UBD update logic 122 can ignore a verification check operation (including omitting performing one) and can clear/reset the refresh flag 404 (e.g., by writing a value of “0”). In some implementations, the second type of update operation 920-2 includes two versions or two types of update operations: a third type of update operation 920-3 and a fourth type of update operation 920-4.

To differentiate between the third and fourth types of update operations 920-3 and 920-4, the UBD update logic 122 determines at block 910 if the refresh boundary is affirmative. To do so, the UBD update logic 122 can analyze the refresh boundary indication 826 of FIG. 8. The refresh boundary is affirmative if, for example, the current activation address 820 matches the last refresh address 818 or is within a selected refresh distance. For instance, with reference to the table that is presented above with the description of FIG. 8, the refresh boundary can be affirmative if the refresh distance is a match or “+1” or if the refresh distance is a match, “+1,” or “+2.”

If the refresh boundary is affirmative (e.g., if the refresh boundary is zero to plus-one or zero to plus-two) at block 910, the “Yes” branch leads to block 912 and performance of the third type of update operation 920-3. At block 912, the UBD update logic 122 performs a post-refresh, affirmative refresh-boundary update operation. For instance, in addition to clearing the refresh flag 404 of the UBD data 128, the UBD update logic 122 can adjust the activation count 308 to a default value (e.g., zero) or to a value that is based on a refresh gap. After block 912, the update process for this row 302 for this memory-accessing round can end at block 916.

On the other hand, if the refresh boundary is negative (e.g., if the refresh boundary is (i) less than zero or greater than one or (ii) less than zero or greater than two) at block 910, the “No” branch leads to block 914 and performance of the fourth type of update operation 920-4. At block 914, the UBD update logic 122 performs a post-refresh, negative refresh-boundary update operation. For instance, in addition to clearing the refresh flag 404, the UBD update logic 122 can adjust the activation count 308 by incrementing the count (e.g., by one or another designated increment value). After block 914, the update process for this row 302 for this round of memory access can end at block 916.

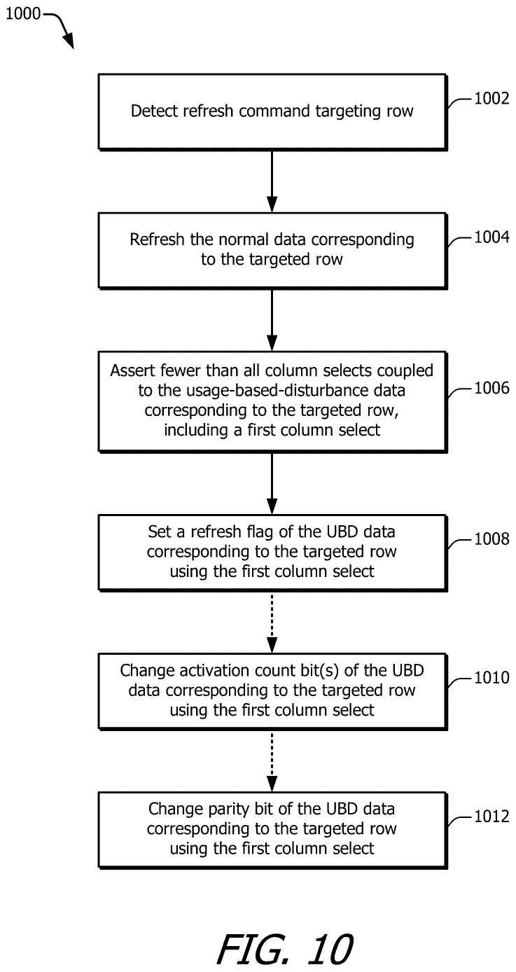

FIG. 10 illustrates an example method 1000 for efficiently updating usage-based-disturbance data in conjunction with a refresh operation. As shown, the method 1000 can include six blocks 1002-1012. In some cases, operations of the method 1000 are implemented by a memory device 108 as described with reference to FIGS. 1 and 2. In particular, the operations of the method 1000 can be performed by the control circuitry 208 of FIG. 2, including the refresh logic 124 or the UBD update logic 122.

In example implementations, at block 1002, the refresh logic 124 detects a refresh command targeting a row 302. At block 1004, the refresh logic 124 refreshes normal data 126 corresponding to the targeted row 302 as part of a refresh operation 134. At block 1006, the refresh logic 124 asserts fewer than all the column selects 408-1 . . . 408-C that are coupled to the usage-based-disturbance data 128 corresponding to the targeted row 302. The at least one asserted column select 408 includes a first column select 408-1 in this example. Here, the variable C represents the column selects 408 that span all storage bits 402-1 . . . 402-B of the UBD data 128. In other words, for block 1006, at least one column select 408 that is coupled to the UBD data 128 is omitted from being asserted. Thus, at least the storage bits 402 that are coupled to the unasserted column select(s) 408 remain unchanged. This saves power during the refresh operation 134.

At block 1008, the refresh logic 124 or the UBD update logic 122 sets the refresh flag 404 of the UDB data 128 corresponding to the targeted row 302 using the first column select 408-1. The refresh flag 404 with the set status indicates that the activation count 308 of the targeted row 302 has not been updated since the row 302 was refreshed. If the storage bits 402 of the first zone 406-1 that is coupled to the first column select 408-1 include at least one activation count bit of the activation count 308 or at least one parity bit 310, then the operation(s) of the block 1010 and the block 1012, respectively, may be performed.

At block 1010, the refresh logic 124 or the UBD update logic 122 may change one or more activation count bits of the activation count 308 of the UDB data 128 corresponding to the targeted row 302 using the first column select 408-1. At block 1012, the refresh logic 124 or the UBD update logic 122 may change at least one parity bit 310 of the UDB data 128 corresponding to the targeted row 302 using the first column select 408-1. The changing or adjusting of these storage bit(s) 402 may include writing a determined value into the storage bits 402.

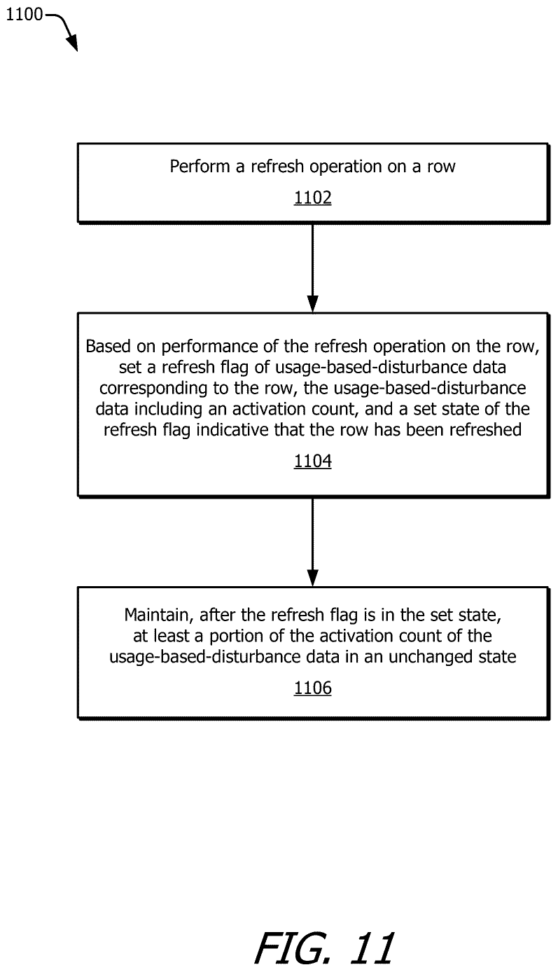

FIG. 11 illustrates an example method 1100 for enabling efficient usage-based-disturbance mitigation. As shown, the method 1100 can include three blocks 1102-1106. In some cases, operations of the method 1100 are implemented by a memory device 108 as described with reference to FIGS. 1 and 2. In particular, the operations of the method 1100 can be performed by the control circuitry 208 of FIG. 2, including by the refresh logic 124.

At block 1102, a refresh operation is performed on a row. For example, a memory device 108 can perform a refresh operation 134 on a row 302. To do so, refresh logic 124 may restore the intended charges on each memory cell 306 that forms normal data 126 of row 302.

At block 1104, based on performance of the refresh operation on the row, a refresh flag of usage-based-disturbance data corresponding to the row is set, with the usage-based-disturbance data including an activation count, and a set state of the refresh flag indicative that the row has been refreshed. For example, based on performance of the refresh operation 134 on the row 302, the memory device 108 can set a refresh flag 404 of usage-based-disturbance data 128 corresponding to the row 302. The usage-based-disturbance data 128 includes an activation count 308, and a set state of the refresh flag 404 (e.g., as indicated by the “X” in the second time period for the memory array 204-2) is indicative that the row 302 has been refreshed. For instance, in conjunction with, or as part of, the refresh operation 134, the refresh logic 124 may set the refresh flag 404 (e.g., to a logical value of “1”) to represent that the UBD data 128 of the row 302 has not been updated since the most-recent refresh operation 134 on the row. In some cases, the refresh logic 124 may alter or change 704 at least one activation count bit of the activation count 308 (e.g., of the portion 308a) in conjunction with the setting 702 of the refresh flag 404 by activating a same column select 408.

At block 1106, after the refresh flag is in the set state, at least a portion of the activation count of the usage-based-disturbance data is maintained in an unchanged state. For example, the memory device 108 can maintain, after the refresh flag 404 is in the set state, at least a portion 308b of the activation count 308 of the usage-based-disturbance data 128 in an unchanged state. Here, by refraining from activating one or more other column selects 408 that are coupled to the activation count 308 of the UBD data 128, the refresh logic 124 leaves at least some activation count bits of the activation count 308 unchanged after the refresh flag 404 has been set and thus saves power.

For the figures described above, the order in which operations are shown and/or described is not intended to be construed as a limitation. Any number or combination of the described process operations can be combined or rearranged in any order to implement a given method or an alternative method. Operations may also be omitted from or added to the described methods. Further, described operations can be implemented in fully or partially overlapping manners. Additionally, the processes and the operations thereof across the different methods of FIGS. 9, 10, and 11 may be implemented separately or in conjunction with one another. For example, the actions of block 1006 may be performed in conjunction with those of block 1104. Further, the operations of FIG. 9 may be performed after, and based on, the performance of the operations of FIG. 11.

Aspects of these methods may be implemented in, for example, hardware (e.g., fixed-circuit circuitry or a processor in conjunction with a memory), firmware, software, or some combination thereof. The method may be realized using one or more of the apparatuses, components, or other aspects shown in FIGS. 1 to 8, the components of which may be further divided, combined, rearranged, and so on. The devices and components of these figures generally represent hardware, such as electronic devices, packaged modules, IC chips, or circuits; firmware or the actions thereof; software; or a combination thereof. Thus, these figures illustrate some of the many possible systems or apparatuses capable of implementing the described methods.

Computer-readable media includes both non-transitory computer storage media and communication media including any medium that facilitates transfer of a computer program (e.g., an application) or data from one entity to another. Non-transitory computer storage media can be any available medium accessible by a computer, such as RAM, ROM, Flash, EEPROM, optical media, and magnetic media.

In the following, various examples for implementing aspects of enabling efficient usage-based-disturbance mitigation are described:

Example 1: A memory device comprising:
a memory array comprising:
   usage-based-disturbance data corresponding to a row, the usage-based-disturbance data comprising an activation count and a refresh flag indicative of a refresh status of the row; and
control circuitry coupled to the memory array, the control circuitry configured to:
   perform a refresh operation on the row;
   set the refresh flag of the usage-based-disturbance data to indicate that the row has been refreshed based on performance of the refresh operation on the row; and
   maintain, after the refresh flag has been set, at least a portion of the activation count in an unchanged state based on the performance of the refresh operation on the row.

Example 2: The memory device of example 1, or any other example(s) described herein, wherein the control circuitry is configured to:
set the refresh flag of the usage-based-disturbance data to indicate that the row has been refreshed by activating a first column select of multiple column selects that correspond to the usage-based-disturbance data, the first column select coupled to the refresh flag; and
maintain, after the activating of the first column select, the at least a portion of the activation count in the unchanged state by omitting activation of a second column select of the multiple column selects that correspond to the usage-based-disturbance data, the first column select different from the second column select.

Example 3: The memory device of example 2, or any other example(s) described herein, wherein:
the first column select is coupled to at least one storage bit of the activation count corresponding to the row.

Example 4: The memory device of example 3, or any other example(s) described herein, wherein:
the at least one storage bit of the activation count comprises a least significant bit of the activation count corresponding to the row.

Example 5: The memory device of example 2, or any other example(s) described herein, wherein:
the second column select is coupled to multiple storage bits of the activation count.

Example 6: The memory device of example 5, or any other example(s) described herein, wherein:
the second column select is coupled to at least one check bit of the usage-based-disturbance data.

Example 7: The memory device of example 2, or any other example(s) described herein, wherein:
the first column select is coupled to at least one check bit of the usage-based-disturbance data.

Example 8: The memory device of example 7, or any other example(s) described herein, wherein the control circuitry is configured to:
store a determined value in the at least one check bit based on at least one of setting the refresh flag or the performance of the refresh operation on the row.

Example 9: The memory device of example 1, or any other example(s) described herein, wherein the control circuitry is configured to:
determine that the row is being accessed for a memory read or write request; and
responsive to a determination that the row is being accessed, update the usage-based-disturbance data using an operation that depends on the refresh status of the refresh flag.

Example 10: The memory device of example 9, or any other example(s) described herein, wherein the control circuitry is configured to:
determine the refresh status of the refresh flag; and
responsive to the refresh flag having a cleared status, perform a first type of update operation on the usage-based-disturbance data corresponding to the row; or
responsive to the refresh flag having a set status, perform a second type of update operation on the usage-based-disturbance data corresponding to the row, the first type of update operation different from the second type of update operation.

Example 11: The memory device of example 10, or any other example(s) described herein, wherein:
the first type of update operation comprises a normal update operation on the usage-based-disturbance data corresponding to the row.

Example 12: The memory device of example 11, or any other example(s) described herein, wherein:
the second type of update operation depends on a refresh boundary relative to the row that is being accessed for the memory read or write request.

Example 13: The memory device of example 12, or any other example(s) described herein, wherein the control circuitry is configured to:
determine the refresh boundary based on a differential between an activation address of the row that is being accessed for the memory read or write request and a refresh address of a most-recent refresh operation.

Example 14: The memory device of example 13, or any other example(s) described herein, wherein:
the refresh boundary is indicative of whether the differential is zero or positive one.

Example 15: The memory device of example 12, or any other example(s) described herein, wherein:
the second type of update operation comprises clearing the refresh flag;
the second type of update operation comprises two types of update operations related to a first update operation of a given row after the given row has experienced a refresh operation;
the two types of update operations comprise a third type of update operation and a fourth type of update operation; and
the control circuitry is configured to:
   responsive to the refresh boundary being affirmative, perform the third type of update operation on the usage-based-disturbance data corresponding to the row; or
   responsive to the refresh boundary being negative, perform the fourth type of update operation on the usage-based-disturbance data corresponding to the row.

Example 16: A method performed by a memory device to support usage-based-disturbance mitigation, the method comprising:
performing a refresh operation on a row;
based on the performing of the refresh operation on the row, setting a refresh flag of usage-based-disturbance data corresponding to the row, the usage-based-disturbance data comprising an activation count, a set state of the refresh flag indicative that the row has been refreshed; and
maintaining, after the refresh flag is in the set state, at least a portion of the activation count of the usage-based-disturbance data in an unchanged state.

Example 17: The method of example 16, or any other example(s) described herein, wherein:
the setting of the refresh flag comprises driving a first column select coupled to the usage-based-disturbance data responsive to the performing of the refresh operation, the first column select coupled to the refresh flag and at least one storage bit corresponding to the activation count; and
the maintaining comprises refraining from driving a second column select coupled to the usage-based-disturbance data responsive to the performing of the refresh operation, the second column select coupled to multiple storage bits of the at least a portion of the activation count, the multiple storage bits excluding the at least one storage bit coupled to the first column select.

Example 18: The method of example 17, or any other example(s) described herein, further comprising:
after the maintaining, activating the row responsive to a memory read or write request; and
responsive to the activating, driving the second column select to alter the unchanged state of the multiple storage bits of the at least a portion of the activation count.

Example 19: A memory device comprising:
multiple storage bits comprising a first storage bit and a second storage bit,
   the multiple storage bits configured to store usage-based-disturbance data corresponding to a row including normal data, the usage-based-disturbance data comprising:
      an activation count corresponding to the normal data of the row; and
      a refresh flag indicative of a refresh status of the row, and
   the multiple storage bits separated into multiple zones with each zone of the multiple zones comprising a subset of the multiple storage bits, a first zone of the multiple zones comprising the first storage bit configured to store the refresh flag and the second storage bit configured to store a least significant bit (LSB) of the activation count; and
multiple column selects, each column select of the multiple column selects respectively coupled to a zone of the multiple zones.

Example 20: The memory device of example 19, or any other example(s) described herein, wherein:
a second zone of the multiple zones comprises at least two storage bits of the multiple storage bits, the at least two storage bits configured to store at least two activation count bits of the activation count;
the multiple column selects comprise a first column select and a second column select;
the first column select is coupled to the first zone; and
the second column select is coupled to the second zone.

Example 21: The memory device of example 20, or any other example(s) described herein, further comprising:
control circuitry coupled to the multiple storage bits, the control circuitry configured, responsive to a refresh operation being performed on the row, to:
   drive the first column select to set the refresh flag; and
   refrain from driving the second column select to maintain the at least two activation count bits of the activation count unchanged.

Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). Also, as used herein, a phrase referring to “at least one of” a list of items refers to any combination of those items, including single members. For instance, “at least one of a, b, or c” can cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c, or any other ordering of a, b, and c). Further, items represented in the accompanying figures and terms discussed herein may be indicative of one or more items or terms, and thus reference may be made interchangeably to single or plural forms of the items and terms in this written description.

### CONCLUSION

Although aspects of enabling efficient usage-based-disturbance mitigation have been described in language specific to certain features and/or methods, the subject of the appended claims is not necessarily limited to the specific features or methods described. Rather, the specific features and methods are disclosed as a variety of example implementations of enabling efficient usage-based-disturbance mitigation.

What is claimed is:

1. A memory device comprising:
a memory array comprising:
usage-based-disturbance data corresponding to a row, the usage-based-disturbance data comprising an activation count and a refresh flag indicative of a refresh status of the row; and
control circuitry coupled to the memory array, the control circuitry configured to:
perform a refresh operation on the row;
set the refresh flag of the usage-based-disturbance data to indicate that the row has been refreshed based on performance of the refresh operation on the row; and
maintain, after the refresh flag has been set, at least a portion of the activation count in an unchanged state based on the performance of the refresh operation on the row.

2. The memory device of claim 1, wherein the control circuitry is configured to:
set the refresh flag of the usage-based-disturbance data to indicate that the row has been refreshed by activating a first column select of multiple column selects that correspond to the usage-based-disturbance data, the first column select coupled to the refresh flag; and
maintain, after the activating of the first column select, the at least a portion of the activation count in the unchanged state by omitting activation of a second column select of the multiple column selects that correspond to the usage-based-disturbance data, the first column select different from the second column select.

3. The memory device of claim 2, wherein:
the first column select is coupled to at least one storage bit of the activation count corresponding to the row.

4. The memory device of claim 3, wherein:
the at least one storage bit of the activation count comprises a least significant bit of the activation count corresponding to the row.

5. The memory device of claim 2, wherein:
the second column select is coupled to multiple storage bits of the activation count.

6. The memory device of claim 5, wherein:
the second column select is coupled to at least one check bit of the usage-based-disturbance data.

7. The memory device of claim 2, wherein:
the first column select is coupled to at least one check bit of the usage-based-disturbance data.

8. The memory device of claim 7, wherein the control circuitry is configured to:
store a determined value in the at least one check bit based on at least one of setting the refresh flag or the performance of the refresh operation on the row.

9. The memory device of claim 1, wherein the control circuitry is configured to:
determine that the row is being accessed for a memory read or write request; and
responsive to a determination that the row is being accessed, update the usage-based-disturbance data using an operation that depends on the refresh status of the refresh flag.

10. The memory device of claim 9, wherein the control circuitry is configured to:
determine the refresh status of the refresh flag; and
responsive to the refresh flag having a cleared status, perform a first type of update operation on the usage-based-disturbance data corresponding to the row; or
responsive to the refresh flag having a set status, perform a second type of update operation on the usage-based-disturbance data corresponding to the row, the first type of update operation different from the second type of update operation.

11. The memory device of claim 10, wherein:
the first type of update operation comprises a normal update operation on the usage-based-disturbance data corresponding to the row.

12. The memory device of claim 11, wherein:
the second type of update operation depends on a refresh boundary relative to the row that is being accessed for the memory read or write request.

13. The memory device of claim 12, wherein the control circuitry is configured to:
determine the refresh boundary based on a differential between an activation address of the row that is being accessed for the memory read or write request and a refresh address of a most-recent refresh operation.

14. The memory device of claim 13, wherein:
the refresh boundary is indicative of whether the differential is zero or positive one.

15. The memory device of claim 12, wherein:
the second type of update operation comprises clearing the refresh flag;
the second type of update operation comprises two types of update operations related to a first update operation of a given row after the given row has experienced a refresh operation;
the two types of update operations comprise a third type of update operation and a fourth type of update operation; and
the control circuitry is configured to:
responsive to the refresh boundary being affirmative, perform the third type of update operation on the usage-based-disturbance data corresponding to the row; or
responsive to the refresh boundary being negative, perform the fourth type of update operation on the usage-based-disturbance data corresponding to the row.

16. A method performed by a memory device to support usage-based-disturbance mitigation, the method comprising:
performing a refresh operation on a row;
based on the performing of the refresh operation on the row, setting a refresh flag of usage-based-disturbance data corresponding to the row, the usage-based-disturbance data comprising an activation count, a set state of the refresh flag indicative that the row has been refreshed; and
maintaining, after the refresh flag is in the set state, at least a portion of the activation count of the usage-based-disturbance data in an unchanged state.

17. The method of claim 16, wherein:
the setting of the refresh flag comprises driving a first column select coupled to the usage-based-disturbance data responsive to the performing of the refresh operation, the first column select coupled to the refresh flag and at least one storage bit corresponding to the activation count; and
the maintaining comprises refraining from driving a second column select coupled to the usage-based-disturbance data responsive to the performing of the refresh operation, the second column select coupled to multiple storage bits of the at least a portion of the activation count, the multiple storage bits excluding the at least one storage bit coupled to the first column select.

18. The method of claim 17, further comprising:
after the maintaining, activating the row responsive to a memory read or write request; and
responsive to the activating, driving the second column select to alter the unchanged state of the multiple storage bits of the at least a portion of the activation count.

19. A memory device comprising:
multiple storage bits comprising a first storage bit and a second storage bit,
the multiple storage bits configured to store usage-based-disturbance data corresponding to a row including normal data, the usage-based-disturbance data comprising:
an activation count corresponding to the normal data of the row; and
a refresh flag indicative of a refresh status of the row, and
the multiple storage bits separated into multiple zones with each zone of the multiple zones comprising a subset of the multiple storage bits, a first zone of the multiple zones comprising the first storage bit configured to store the refresh flag and the second storage bit configured to store a least significant bit (LSB) of the activation count; and
multiple column selects, each column select of the multiple column selects respectively coupled to a zone of the multiple zones.

20. The memory device of claim 19, wherein:
a second zone of the multiple zones comprises at least two storage bits of the multiple storage bits, the at least two storage bits configured to store at least two activation count bits of the activation count;
the multiple column selects comprise a first column select and a second column select;
the first column select is coupled to the first zone; and
the second column select is coupled to the second zone.
